(19) United States
(12) Patent Application Publication
(10) Pub. No.: US 2023/0070971 A1
(43) Pub. Date: Mar. 9, 2023

(54) CONSTRUCTION MACHINE

(71) Applicant: Deere & Company, Moline, IL (US)

(72) Inventors: Carlos C. Gonzalez, Madrid (ES); Hector H. Ballester, Madrid (ES)

(21) Appl. No.: 17/813,413

(22) Filed: Jul. 19, 2022

(30) Foreign Application Priority Data
Sep. 7, 2021 (DE) 102021123147.7

(51) Int. Cl. E02F 9/26; E02F 3/76

(52) U.S. Cl. CPC E02F 9/267; E02F 3/764; B60Q 9/00

(57) ABSTRACT

A construction machine comprising a main frame, a blade carrier frame, and a slewing ring arrangement comprising a blade which is mounted thereon, wherein the slewing ring arrangement comprises a toothed ring which is connected to a drive pinion which rotates and which is connected to a drive motor which is mounted on the blade carrier frame, the toothed ring having a guide ring, which is guided by a plurality of slide bearing shoes which are arranged over the circumference thereof and which are mounted on the blade carrier frame, wherein wear linings which are in sliding contact with the guide ring are arranged between the slide bearing shoes and the guide ring. An indicator device is provided, a change in a distance of the toothed ring radially to a second rotational axis being able to be detected thereby.

### FIELD OF THE DISCLOSURE

The present disclosure relates generally to a construction machine and more particularly to a monitoring device for monitoring wear linings of a slewing ring arrangement.

### BACKGROUND OF THE DISCLOSURE

The invention relates to a construction machine comprising a main frame, a blade carrier frame which is arranged on the main frame, and a slewing ring arrangement which is rotatably mounted about a first rotational axis relative to the blade carrier frame, comprising a blade which is mounted thereon for grading a ground surface. The slewing ring arrangement comprises a toothed ring which is connected to a drive pinion which rotates about a second rotational axis and which is connected to a drive motor which is mounted on the blade carrier frame. The toothed ring has a guide ring, which encloses the rotational axis and which extends in the axial direction to the rotational axis, and which is guided by a plurality of slide bearing shoes which are arranged over the circumference thereof and which are mounted on the blade carrier frame, and which is fixed radially to the rotational axis. Wear linings which are in sliding contact with the guide ring are arranged between the slide bearing shoes and the guide ring.

Such construction machines are known in the prior art, in particular as grading vehicles for leveling operations in the construction industry and in road building. Such construction machines are also known as motor graders or road graders and are used to flatten or to grade the ground surface or sloping surfaces during the construction of a road or a building.

A motor grader of the type mentioned above is disclosed, for example, in DE 11 2011 101 271 T5 and has a steerable front frame and a driven rear frame which is connected to the front frame by an articulated connection. The front frame bears a movable slewing ring arrangement which holds a working implement which is used to carry out levelling operations. The slewing ring arrangement is borne by a carrier plate of the front frame. A movement of the slewing ring arrangement relative to the front frame results in a corresponding movement of the working implement. The working implement is configured as a bucket or plate and is connected to a toothed ring of the slewing ring arrangement. The movement of the slewing ring arrangement is effected by a drive pinion, which is mounted on the front frame and which is connected to an actuating motor, and which is connected in terms of drive to the toothed ring. The toothed ring is rotatably borne relative to the carrier plate by slide bearing shoes which permit the relative rotation between the toothed ring and the carrier plate but block or prevent a translatory displacement radially and axially to the rotational axis.

During operation, the working implement and thus also the slewing ring arrangement are subjected to high forces and vibrations. To reduce the wear on the toothed ring and the drive pinion, wear linings which absorb a large proportion of the forces and vibrations, or which reduce or minimize these forces and vibrations, are provided on the slide bearing shoes. In this context, the wear linings are subjected to significant abrasion and have to be replaced at regular maintenance intervals, in particular after the abrasion surface has worn down. With the increasing abrasion of the wear linings, a translatory relative movement radially to the rotational axis increasingly occurs between the slewing ring arrangement and the drive pinion, which may lead to a direct wear of the toothed ring or the drive pinion which is to be avoided. An omission of the timely replacement of the wear linings thus may lead to damage of the toothed ring and/or the drive pinion, in particular to the abrasion of the teeth present on the drive pinion and thus to the breakdown of the construction machine and to costly repair operations. It is usual to prevent such an omission by regular visual inspection of the slewing ring arrangement, but it is a drawback of construction machines which comprise slewing ring arrangements and which are known in the prior art that the wear linings are poorly visible and often critical wear is only able to be established too late, by obvious consequential damage in the form of traces of wear on the toothed ring and/or on the drive pinion.

The object of the invention is seen to specify a construction machine of the type mentioned in the introduction by which the aforementioned problems are remedied.

### SUMMARY OF THE DISCLOSURE

The object is achieved according to the invention by the teaching of claim 1. Further advantageous embodiments and developments of the invention emerge from the subclaims.

According to the invention, a construction machine of the type mentioned in the introduction is configured such that an indicator device is provided to detect a change in a distance of the toothed ring radially to the second rotational axis. A detection of a change in the distance between the toothed ring and the drive pinion is achieved by the indicator device, such as for example sensors, probes or switches, which permit the radial distance ratios between the toothed ring and the drive pinion to be monitored. Deviating from a designated distance value or exceeding a permitted distance fluctuation indicates that the wear linings on the slide bearing shoes are used up or abraded or worn and translatory relative movements radially to the rotational axis may take place between the toothed ring and the drive pinion or may exceed an unpermitted level, which may lead to damage of the toothed ring and/or the drive pinion. The construction machine may comprise a slewing ring arrangement comprising a toothed ring which is internally toothed, wherein the toothed ring is connected to a drive pinion which is arranged on the inner face of the toothed ring. Alternatively, the construction machine may also comprise a slewing ring arrangement comprising a toothed ring which is externally toothed, wherein the toothed ring is connected to a drive pinion which is arranged on an outer face of the toothed ring. The guide ring may be fixed radially to the rotational axis by being guided via slide bearing shoes which are arranged on the circumference thereof and which are mounted on the blade carrier frame. Depending on the embodiment, the slide bearing shoes may be mounted radially internally or even radially externally relative to the guide ring on the blade carrier frame. The slide bearing shoes support the guide ring and fix this guide ring such that a displacement of the toothed ring radially to the rotational axis thereof and thus also radially to the rotational axis of the drive pinion is prevented.

The indicator device may comprise a distance sensor. The distance sensor may be configured, for example, as a position sensor, travel sensor, displacement sensor, proximity sensor, or as another similar-acting sensor which may detect a changing distance between the toothed ring and the sensor, or another fixed point on the blade carrier frame or another fixed point on the construction machine. The distance sensor may be fixed, for example, to the blade carrier frame and may be positioned at a fixed distance from the toothing of the toothed ring. If a change in the distance between the drive pinion and the toothing on the toothed ring were to occur, this may be indicated or detected by the distance sensor. The indicator device or the distance sensor may be configured as a tactile sensor, contact sensor, push-button switch or touch-sensitive switch which is fixed to the blade carrier frame or another stationary component of the construction machine and which is connected to the toothing on the toothed ring. If the distance between the contact sensor and toothed ring were to change beyond a predeterminable level, so that the contact sensor or contact switch is no longer connected to the toothed ring, an audible or visible warning signal is generated.

A warning signal may be output or may be displayed, for example, via a display device so that a detected change in the radial distance of the toothed ring relative to the rotational axis of the drive pinion is displayed by means of the display device in an audible or visible manner.

It is also possible that the indicator device comprises a wear marking so that with a change in the distance beyond a predeterminable level caused by the displacement of the toothed ring, the wear may be identified or visually displayed by the wear marking which may be noted by an operator, for example during a maintenance inspection, in order to carry out corresponding adjustments and/or a renewal of the wear linings.

Other features and aspects will become apparent by consideration of the detailed description and accompanying drawings.

### BRIEF DESCRIPTION OF THE DRAWINGS

The detailed description of the drawings refers to the accompanying figures in which:

FIG. 1 shows a schematic side view of a motor grader,

FIG. 2 shows a schematic exploded drawing of a blade carrier frame comprising a slewing ring arrangement and a blade of the motor grader of FIG. 1,

FIG. 3 shows a schematic perspective view of the upper face of the slewing ring arrangement of FIG. 2,

FIG. 4 shows a schematic perspective view of the lower face of the slewing ring arrangement of FIGS. 2 and 3,

FIG. 5 shows a schematic side view of the lower face of the slewing ring arrangement of FIGS. 2 to 4,

FIG. 6 shows a schematic perspective partial view of the lower face of the slewing ring arrangement of FIGS. 2 to 5 in enlarged form, and

FIG. 7 shows a schematic partial side view of the lower face of the slewing ring arrangement of FIGS. 2 to 6 in enlarged form.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments of the invention may include any combination of features from one or more dependent claims, and such features may be incorporated, collectively or separately, into any independent claim.

### DETAILED DESCRIPTION OF THE DRAWINGS

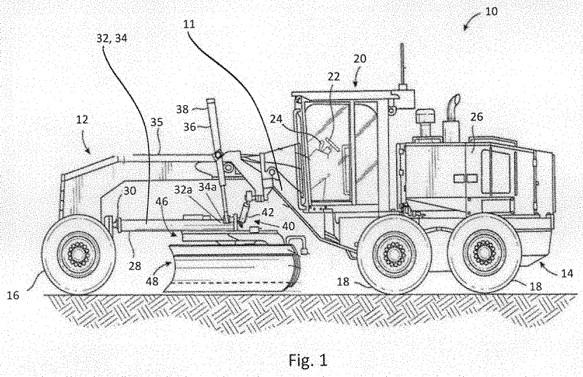

An exemplary embodiment of a construction machine 10 in the form of a motor grader is shown with reference to FIG. 1. The construction machine 10 may be used, amongst other things, in the context of an industry such as mining, road building, landscaping or a similar industry.

As shown in FIG. 1 the construction machine 10 comprises a frame 11 with a front frame region 12 and a rear frame region 14, wherein the front frame region 12 is borne on a pair of front wheels 16 and the rear frame region 14 is borne on a right-hand and left-hand tandem set of rear wheels 18. A driver's cab 20 is arranged on the rear frame region 14 and comprises different control elements for the construction machine which are arranged such that they are located within reach of a seated operator. By way of example, a steering wheel 22 and a lever assembly 24 are shown as control elements. The driver's cab 20 also comprises a display or a monitor (not shown) for displaying information, an alarm, a warning signal or a different type of message which is to be displayed.

A drive motor 26 which delivers the power for all of the driven components of the construction machine 10 is arranged on the rear frame region 14 and drives, amongst other things, the rear wheels 18 via a gearbox, not shown, at various selected speeds in the forward or reverse mode.

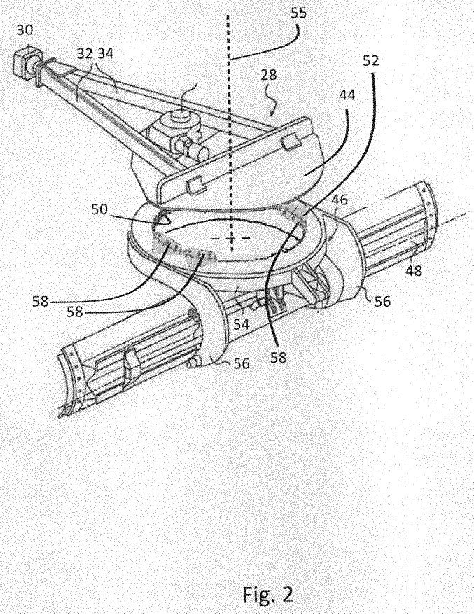

A movable blade carrier frame 28 is attached to a front region of the front frame region 12, the front end thereof being connected via a ball joint arrangement 30 to the front frame region 12. As can be seen particularly clearly from FIG. 2, the blade carrier frame 28 has a right-hand and a left-hand blade carrier frame arm 32 and 34 which, starting from the ball joint arrangement 30, run apart at a spread angle and extend in opposing right-hand and left-hand rear blade carrier frame regions 32a and 34a. The left-hand and right-hand blade carrier frame regions 32a and 34a are suspended on a raised central portion 35 of the front frame region 12 via right-hand and left-hand adjustable (extendable and retractable) hydraulic cylinders 36, 38. The right-hand and left-hand extendable and retractable hydraulic cylinders 36 or 38 lift or lower the right-hand and left-hand rear blade carrier frame regions 32a and 34a of the blade carrier frame 28. A side shifter linkage arrangement 40 which comprises an extendable and retractable hydraulic adjusting member 42 extends between the raised central portion 35 of the front frame 12 and a rear position of the blade carrier frame 28.

As shown in FIG. 2, the right-hand and left-hand rear blade carrier frame regions 32a and 34a of the blade carrier frame 28 are connected to a carrier plate 44. A slewing ring arrangement 46 which is rotatable relative to the blade carrier frame 28 or relative to the carrier plate 44 being coupled thereto. The slewing ring arrangement 46 is connected in turn to a working implement in the form of a blade 48 (or a grader plate) and couples the working implement or the blade 48 to the blade carrier frame 28.

The blade carrier frame 28 may be lifted, lowered or inclined by the right-hand and left-hand lifting linkage arrangements 36 and 38 on its rear region, which in turn lifts, lowers or tilts the blade 48 relative to the surface. The hydraulic adjusting member 42 of the side shifter linkage arrangement 40 displaces the blade carrier frame 28 and the blade 48 to the right or left or adjusts the blade carrier frame 28 to the side relative to the raised central portion 35 of the front frame region 12.

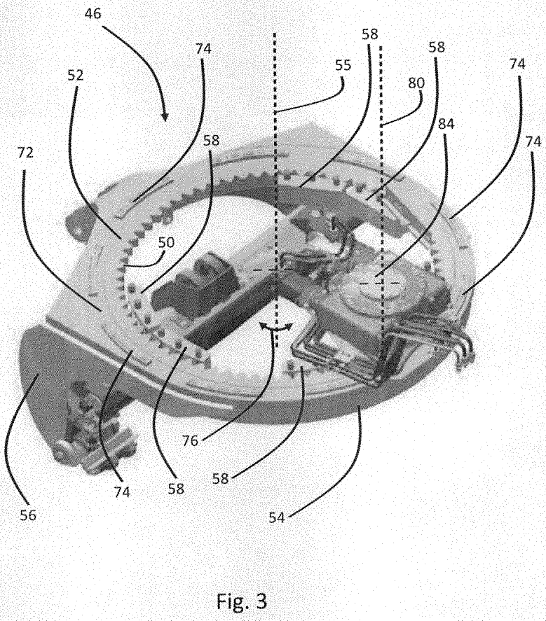

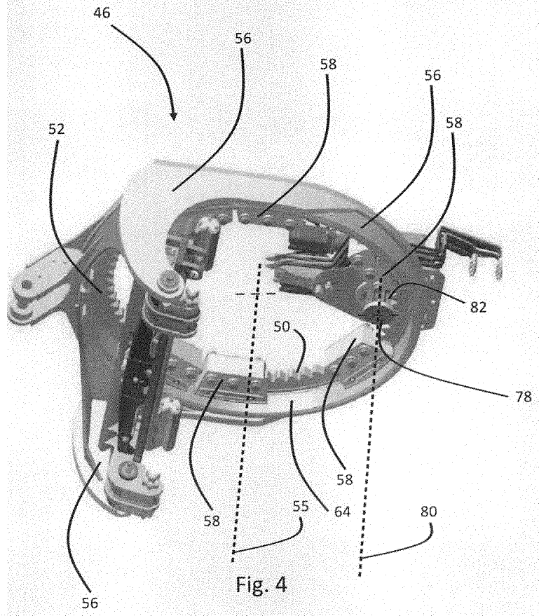

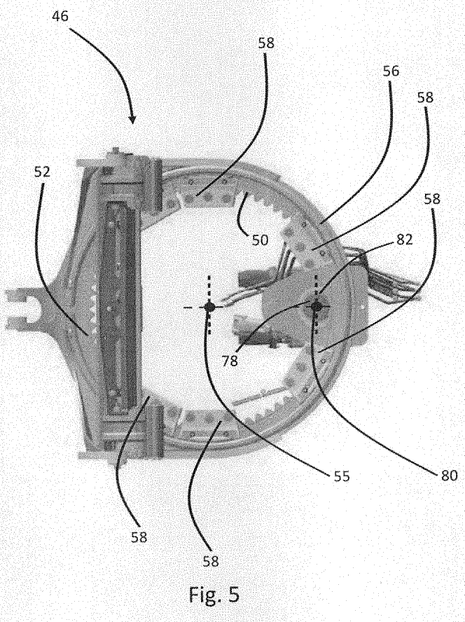

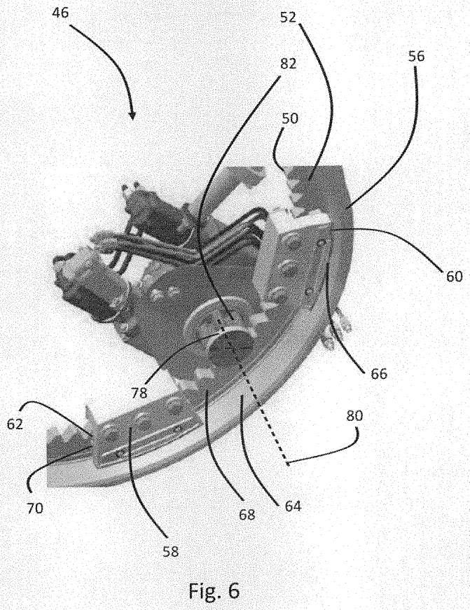

As shown in detail in FIGS. 3 to 7, the slewing ring arrangement 46 comprises a toothed ring 52 which is configured with an internal toothing 50 and which is connected on the circumference thereof to a guide ring 54. The toothed ring 52 and guide ring 54 have a common rotational axis 55 about which the toothed ring 52 or the guide ring 54 may be rotated. A working implement carrier 56 to which the working implement is coupled extends out of the guide ring 54. Moreover, the slewing ring arrangement 46 comprises a plurality of slide bearing shoes 58 which are distributed over the circumference of the guide ring 54. The slide bearing shoes 58 are fixedly connected, for example screwed, to the carrier plate 44. The slide bearing shoes 58 in each case have a first (radial) slide bearing surface 60 in the radial direction to the rotational axis 55 and a second (axial) slide bearing surface 62 in the axial direction to the rotational axis 55. The slide bearing shoes 58 slide along an inner surface 64 of the guide ring 54 on the first slide bearing surfaces 60, wherein radial wear linings 66 are arranged between the first slide bearing surfaces 60 and the inner surface 64 of the guide ring 54. The slide bearing shoes 58 slide along a lower front face 68 of the toothed ring 52 on the second slide bearing surfaces 62, wherein lower axial wear linings 70 are arranged between the second slide bearing surfaces 62 and the lower front face 68 of the toothed ring 52. The guide ring 54, which is fixedly connected to the toothed ring 52, is guided in the radial direction to the rotational axis 55 via the first slide bearing surfaces 60 or via the radial wear linings 66 arranged thereon and thus the toothed ring 52 is radially fixed relative to the carrier plate 44. The toothed ring 52 is fixed at the bottom relative to the carrier plate 44 in an axial direction to the rotational axis 55 via the second slide bearing surfaces 62 or via the axial wear linings 70 arranged thereon. Additionally, upper axial wear linings 74 are arranged on an upper front face 72 of the toothed ring 52, the toothed ring 52 being fixed at the top relative to the carrier plate 44 axially to the rotational axis 55 by said upper axial wear linings. The toothed ring 52 is thus fixed relative to the carrier plate 44 in the axial direction and radial direction to the rotational axis 55 and may be rotated or twisted in the circumferential direction 76 thereof about the rotational axis 55.

The slewing ring arrangement 46 further comprises a drive pinion 78 which rotates about a rotational axis 80. The drive pinion 78 has an external toothing 82 which engages in the internal toothing 50 of the slewing ring 52. The drive pinion 78 is driven via a drive motor 84 which is mounted on the carrier plate 44. The drive motor 84 may be configured, for example, as a hydraulic motor or electric motor.

Moreover, the indicator device is provided to indicate and display a change in the distance between the rotational axis 80 of the drive pinion 78 and the internal toothing 50 of the toothed ring. The indicator device comprises a tactile sensor or distance sensor 86 which is mounted on the carrier plate 44 and which is directly in contact with the internal toothing of the toothed ring 52 or is operatively connected thereto in a different manner and detects a change in the location of the toothed ring 52 relative to the carrier plate 44 and thus also relative to the rotational axis 80 of the drive pinion 78. In other words, with a change in the location of the toothed ring 52 relative to the carrier plate 44 and thus also relative to the rotational axis 80 of the drive pinion 78, a sensor signal or a change in the sensor signal is generated. The corresponding signal or the corresponding change in the signal is detected by a control unit (not shown) and is displayed on a display device or a monitor in the driver's cab 20 in the known manner.

If a distance between the distance sensor 86 and the toothed ring or internal toothing 50 of the toothed ring 52 were to change beyond a predeterminable level, a signaling audible or visible warning signal is generated, said warning signal being output or displayed via a display device or monitor.

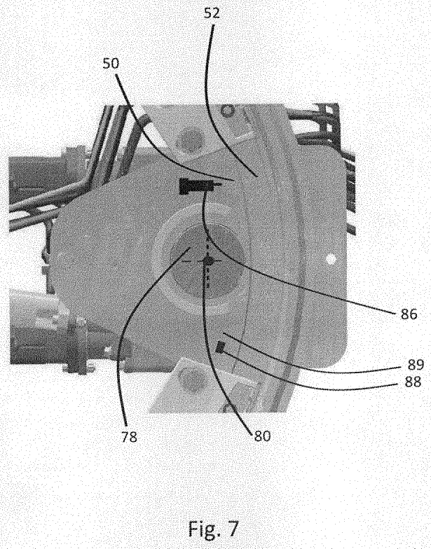

The indicator device may also alternatively comprise a simple wear marking 88 which is arranged, for example, on the lower face of the carrier plate 44, so that with a change in the distance caused by the displacement of the toothed ring beyond a predeterminable level by the radial displacement of the toothed ring 52 relative to the rotational axis 80 of the drive pinion 78, the current wear may be identified or is displayed by this wear marking 88. Thus, in the case of excessive wear, with a two-dimensional wear marking 88, the tooth tips 89 of the internal toothing 50 may run outside the two-dimensional wear marking 88 when the toothed ring 52 is moved. However, if the tooth tips 89 pass through the two-dimensional wear marking 88 (as shown in FIG. 7), the wear is still within the permitted tolerance. By visually inspecting the toothed ring 52 and the relative position thereof to the wear marking 88, an operator is able to note the wear and carry out or arrange corresponding adjustments and/or a renewal of the wear linings.

What is claimed is:

1. A construction machine for operating on a ground surface, the construction machine comprising:
a main frame;
a blade carrier frame coupled to the main frame; and
a slewing ring arrangement rotatably coupled about a first rotational axis relative to the blade carrier frame, the slewing ring arrangement comprising
a blade configured for grading the ground surface, and
a toothed ring coupled to a drive pinion, which rotates about a second rotational axis, and which is coupled to a drive motor which is coupled to the blade carrier frame, the toothed ring having a guide ring, which encloses the first rotational axis, and which extends in the axial direction to the first rotational axis, and which is guided by a plurality of slide bearing shoes, which are arranged over the circumference thereof, and which are coupled to the blade carrier frame, and which is fixed axially and radially to the first rotational axis,
wherein at least one wear lining, which is in sliding contact with the guide ring is arranged between the slide bearing shoes and the guide ring, and
wherein an indicator device is provided to detect a change in a distance of the toothed ring radially to the second rotational axis.

2. The construction machine as claimed in claim 1, wherein the indicator device comprises a distance sensor.

3. The construction machine as claimed in claim 1, wherein a display device is provided, a detected change in the distance being able to be displayed thereby in at least one of an audible or visible manner.

4. The construction machine as claimed in claim 1, wherein the indicator device comprises a wear marking.
